(19) United States
(12) Patent Application Publication
(10) Pub. No.: US 2025/0348746 A1
(43) Pub. Date: Nov. 13, 2025

(54) VARIABLE ACCURACY COMPUTING SYSTEMS

(71) Applicant: Cirrus Logic International Semiconductor Ltd., Edinburgh (GB)

(72) Inventors: Yanto SURYONO, Tokyo (JP); Toru IDO, Tokyo (JP); John P. LESSO, Edinburgh (GB)

(73) Assignee: Cirrus Logic International Semiconductor Ltd., Edinburgh (GB)

(21) Appl. No.: 18/661,071

(22) Filed: May 10, 2024

(51) Int. Cl. G06N 3/091; G06N 3/045

(52) U.S. Cl. CPC G06N 3/091; G06N 3/045

(57) ABSTRACT

A computing system comprising: a computation unit configured to receive a series of input data values and generate a series of output data values by performing operations on at least one received input data value and/or generated output data value; an input to receive a tunable performance parameter separate to the series of input data values; and a controller, wherein the controller is configured, as a function of the received tunable performance parameter, to issue a control signal to the computation unit to control a level of accuracy of the operations and thereby affect a performance metric of the computation unit.

### FIELD OF DISCLOSURE

The present disclosure relates to the field of variable accuracy computing systems, in particular in relation to artificial neural network (ANN) circuitry for example configured to operate as a Large Language Model (LLM).

### BACKGROUND

There are a number of computing applications which may, in operation, require a significant amount of computation. For instance, artificial neural networks (ANNs) are computationally intensive and are increasingly being proposed for use in a number of different areas, e.g. for classification or recognition purposes.

LLMs are example ANNs generally known as language models capable of general-purpose language generation and other natural language processing (NLP) tasks. The computational energy requirements for LLM inference are considerable and continue to escalate as the language models become more complex. Additionally, both the training and inference stages have traditionally been performed by centralised servers or “in the cloud”, receiving inputs from and providing resultant outputs to so-called “edge” devices, e.g. mobile phones, laptops, tablet computers, “smart” devices and so on. However, increasingly there is a drive to perform at least the inference in ANN circuitry provided locally in edge devices. Such ANN circuitry may for example receive trained weights from training processes performed remotely.

The trend towards providing computing systems such as local neural nets and inference systems within edge devices exacerbates energy-requirement concerns and is driving requirements for increased flexibility and reduced power consumption.

### SUMMARY

According to a first aspect of the present disclosure, there is provided a computing system comprising: a computation unit configured to receive a series of input data values and generate a series of output data values by performing operations on at least one received input data value and/or generated output data value; an input to receive a tunable performance parameter separate to the series of input data values; and a controller, wherein the controller is configured, as a function of the received tunable performance parameter, to issue a control signal to the computation unit to control a level of accuracy of the operations (and thereby affect a performance metric of the computation unit).

By controlling the computation unit in this way, it is possible to control its performance taking into account factors such as power consumption.

According to a second aspect of the present disclosure, there is provided an integrated circuit comprising a computing system according to the first aspect.

According to a third aspect of the present disclosure, there is provided a device comprising an integrated circuit according to the second aspect, optionally wherein the device is a mobile telephone, a tablet or laptop computer or an Internet of Things (IoT) device.

According to a fourth aspect of the present disclosure, there is provided a computing method comprising: receiving, at a computation unit of a computing system, a series of input data values; receiving, at an input of the computing system, a tunable performance parameter separate to the series of input data values, generating, at the computation unit, a series of output data values by performing operations on at least one received input data value and/or generated output data value; and controlling, by a controller of the computing system and as a function of the received tunable performance parameter, a level of accuracy of the operations and thereby affecting a performance metric of the computation unit.

According to a fifth aspect of the present disclosure, there is provided a method of controlling a computation unit, the computation unit configured to receive a series of input data values and generate a series of output data values by performing operations on at least one received input data value and/or generated output data value, the method comprising: controlling, as a function of a received tunable performance parameter, a level of accuracy of the operations and thereby affecting a performance metric of the computation unit.

According to a sixth aspect of the present disclosure, there is provided a method of training/configuring a controller of a computing system comprising a computation unit and said controller, the computation unit configured to receive a series of input data values and generate a series of output data values by performing operations on at least one received input data value and/or generated output data value, the controller configured, as a function of a tunable performance parameter, to issue a control signal to the computation unit to control a level of accuracy of the operations and thereby affect a performance metric of the computation unit, the method comprising: varying a value of the tunable performance parameter and defining said function based on an effect of varying the value of the tunable performance parameter on the performance metric; and/or varying a value of the control signal and defining said function based on an effect of varying the value of the control signal on the performance metric; and/or providing the computation unit with one or more training sets of input data values and defining said function based on an effect of the one or more training sets of input data values on the performance metric.

According to a seventh aspect of the present disclosure, there is provided a computer program which, when executed on one or more processors of a computing system, causes the computing system to carry out the method of any of the fourth to sixth aspects.

According to an eighth aspect of the present disclosure, there is provided a non-transitory computer readable storage medium having the computer program of the seventh aspect stored thereon.

Corresponding apparatus/device aspects, method aspects, computer program aspects and storage medium aspects are envisaged. Features of one aspect may be applied to another and vice versa.

### BRIEF DESCRIPTION OF THE DRAWINGS

Reference will now be made, by way of example only, to the accompanying drawings, of which:

FIG. 1 is a schematic representation of a computing system useful for understanding embodiments of the present invention;

FIG. 2 is a schematic representation of a variable accuracy computing system embodying the present invention;

FIG. 3 is a schematic representation of a variable accuracy computing system embodying the present invention;

FIG. 4 is a schematic representation of a variable accuracy computing system embodying the present invention;

FIG. 5 is a flowchart representation of a computing method which may be carried out by the variable accuracy computing system of any of FIGS. 2 to 4;

FIG. 6 is a flowchart representation of a method of controlling the computation unit of the variable accuracy computing system of any of FIGS. 2 to 4;

FIG. 7 is a flowchart representation of a method of training/configuring the controller unit of the variable accuracy computing system of any of FIGS. 2 to 4;

FIG. 8 is a simplified schematic representation of a neuron (or part thereof) for an ANN;

FIG. 9 is a simplified schematic representation of an analog crossbar array for use in a neuron (or part thereof) for an ANN;

FIG. 10 is a simplified schematic representation of a multiplication operation performed by an analog crossbar array arrangement;

FIG. 11 is a simplified schematic representation of a multiplication operation performed by an alternative analog crossbar array arrangement; and

FIG. 12 is a schematic representation of a device incorporating the variable accuracy computing system of any of FIGS. 2 to 4.

### DETAILED DESCRIPTION

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

ANNs and specifically LLMs will be adopted herein as a convenient running example of computationally intensive computing applications to which the present invention may be applied.

By way of introduction, and in simplistic terms, an ANN (or, simply, neural network) typically includes an input layer of nodes or neurons, an output layer of nodes or neurons and, optionally, one or more layers (often referred to as “hidden layers”) of nodes or neurons intermediate the input layer and the output layer. Each layer is connected to its successor layer by connections between the nodes of the layers that transfer data from a node of a layer to a node of the successor layer.

Each node or neuron of a layer typically has multiple inputs, and a weight is assigned to each input of each node in a learning or training stage. During this learning or training stage, known training data is supplied to a layer of the neural network and individual neurons of the layer assign weights to their inputs based on the task being performed. By comparing the resultant outputs with the known training data, and repeating over a series of iterations, the neural network learns the optimum weights to assign to the inputs of the neurons for the task being performed.

During subsequent use of the neural network, operational input data is supplied to the input layer of the neural network. Data applied to a neuron of the input layer is weighted according to the weights assigned to the inputs of the neuron—i.e. the neuron applies the weight assigned to each of its inputs to the data received at the respective inputs. The neuron sums the weighted input data (and optionally performs a non-linear activation function on the sum of the weighted input data) to generate an output data value, which is transmitted to one or more neurons of the next layer of the neural network, which may be an output layer or an intermediate layer. The use of a trained neural network to apply weights to operational input data is known as inference.

Such computing is often performed purely in the digital domain however it may be carried out in the digital and/or analog domain.

In the context of LLMs, the overall ANN concerned may be configured to receive a series of input data values and generate a series of output data values by performing operations on at least one received input data value and/or generated output data value. The input data values may be referred to as input tokens and the output data values as output tokens. Tokens here may represent whole words or parts of words as a simplistic example. More generally, a token in the context of LLMs may be taken as a unit of text that is segmented so that the LLM can process it efficiently. These units could be words or any other subset of language, such as parts of words, combinations of words or word parts, or punctuation. Against this backdrop, LLMs may be considered to analyse a series of input tokens to predict one or more (output) tokens.

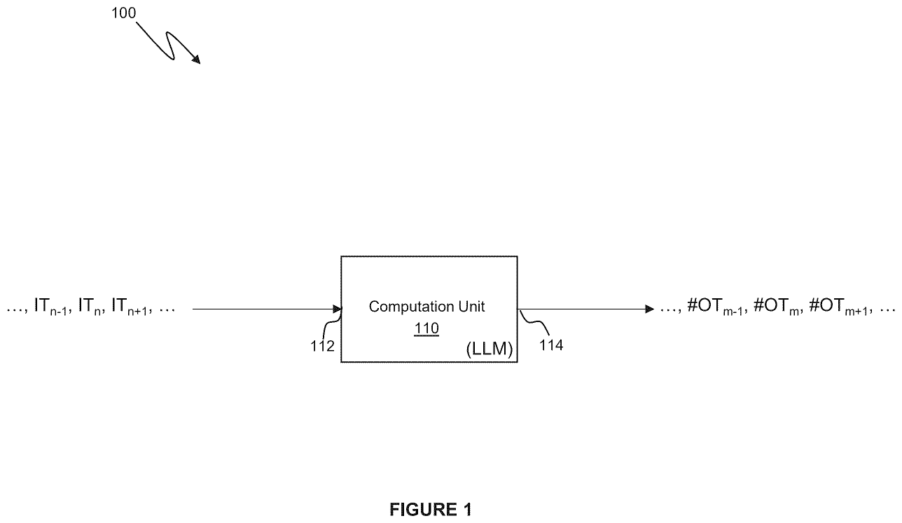

FIG. 1 is a schematic diagram of a computing system 100 which, in the illustrated example, implements an ANN system and specifically an LLM in line with the running example. However, the computing system 100 may be applied to other computing applications and the present disclosure will be understood accordingly.

The computing system 100 may be considered a host system or a host device or part thereof. For example, the computing system 100 may be provided for use within a host system or a host device. Such a host system or host device may be an edge device and may be referred to simply as a host.

The computing system 100 includes a computation unit 110 configured for receiving a series of input data values and generating a series of output data values by performing operations on at least one received input data value and/or generated output data value. The computation unit 110 has one or more data inputs 112 for receiving input data values and one or more outputs 114 for outputting generated output data values.

As above, the computation unit 110 is taken in this example to implement (or operate as) an LLM. As such, the input data values are indicated as a series of input tokens IT, including ITₙ₋₁, ITₙ, and ITₙ₊₁ by way of example, where n is a counter value. Similarly, the output data values are indicated as a series of output tokens OT, including #OTₘ₋₁, #OTₘ, and #OTₘ₊₁ by way of example, where m is a counter value. The output tokens are prefixed with # in FIG. 1 to indicate that they have not been subjected to the techniques of the preset invention; the # prefix is omitted from output tokens in subsequent arrangements.

The input and output tokens may, but typically do not, have a one-to-one correspondence. For example, plural input tokens may be employed to generate an output token, or an input token may be employed to generate plural output tokens. A series of input tokens may be employed to generate a series of output tokens where the number of tokens in the two series may be the same or different. Counter values m and n may or may not be mutually synchronized.

The LLM of the computation unit 110 may itself have been trained by a separate training exercise, thereby learning the optimum weight values to be employed during subsequent operation of the LLM (known as inference). In other arrangements, an equivalent LLM (e.g. of the same configuration and with the same intended use case) may have been trained separately and weight values resulting from that training exercise provided to the computation unit 110 for use by its LLM. Either way, the LLM of the computation unit 110 may be considered a trained LLM and similar considerations apply to the other computation units disclosed later herein. For example, the computation unit 110 may comprise a generative pre-trained transformer. The skilled person will understand the principles of training an LLM and such details are thus omitted herein for the sake of brevity.

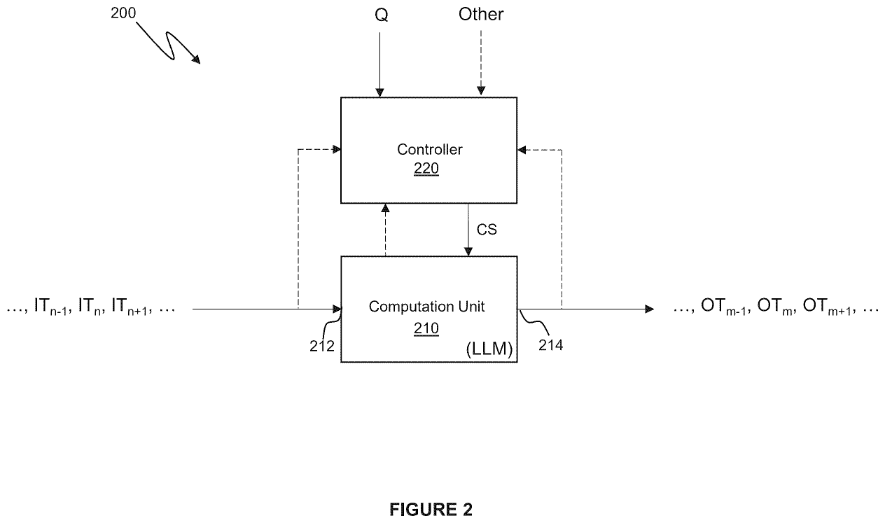

FIG. 2 is a schematic diagram of a computing system 200 embodying the present invention. The computing system 200 is similar to the computing system 100 in that it includes a computation unit 210 with one or more data inputs 212 for receiving input data values and one or more outputs 214 for outputting output data values. The computation unit 210, like the computation unit 110, is configured for receiving a series of input data values and generating a series of output data values by performing operations on at least one received input data value (or value derived therefrom) and/or generated output data value (or value derived therefrom). Taking forwards the running example, respective series of input tokens and output tokens are also assumed in line with FIG. 1, but with the output tokens not having the prefix # as mentioned earlier.

Computing system 200 differs from computing system 100 in that it comprises a controller 220. The controller 220 is configured, as a function of a tunable performance parameter Q, to issue a control signal CS to the computation unit 210 to control a level of accuracy/precision of the operations it performs and thereby affect a performance metric of the computation unit 210. That is, the controller 220 is configured to control a value of the control signal CS as a function of the tunable performance parameter Q. In this way, the value of the tunable performance parameter Q may affect the performance metric of the computation unit 210. The computing system 200 may be referred to as a variable accuracy computing system.

The computation unit 210 and/or controller 220 may comprise digital and/or analog circuitry, such as neural network circuitry. The computation unit 210 and/or controller 220 may be referred to as circuitry or circuits.

As an overview, in the context of the LLM running example, the computing system 200 may be intended to control the accuracy/precision of the LLM operations performed by the computation unit 210 (which may, for example, affect power consumption) with the understanding that this may affect the overall LLM performance, and thus the user experience. This control is based at least on the tunable performance parameter Q. An example use case is enabling the performance of the LLM to be ‘turned down’ as an effect of a corresponding change in the performance parameter Q value, for instance to save power when it is deemed that a drop in LLM performance can be tolerated. An example goal may be to reduce the precision per weight (used in operations performed by the computation unit 210), with the intent that in aggregate for every positive error this introduces to one weight it introduces a compensating negative error to another weight-thus, despite a loss in precision per weight (i.e. computing accuracy) the overall accuracy of the system is substantially maintained. Thus, there may be a desire to maintain, or reduce/limit a negative impact on, accuracy even if precision in individual operations is reduced, and the present disclosure will be understood accordingly.

The performance metric of the computation unit 210 may comprise a perplexity metric or simply perplexity, which, as known to the skilled person, is a metric for assessing or evaluating how “good” an LLM is, for example the LLM quality. An LLM with a (desirable) low perplexity value may provide outputs which are well aligned with the expected outputs from a human point of view. Conversely, an LLM with a (undesirable) high perplexity value may provide outputs which are somewhat surprising or perplexing from a human point of view, for example being inappropriate to a degree given the inputs. Other known performance metrics in the context of LLMs include BLEU (Bilingual Evaluation Understudy) and ROUGE (Recall-Oriented Understudy for Gisting Evaluation), and these of course a just examples known to the skilled person such that a detailed explanation here is not needed. LLM performance may be evaluated by humans, rating the LLM output based on criteria such as quality, coherence and relevance, albeit such evaluation may be inherently subjective at least to a degree. As LLMs are typically used for understanding, generating, and interacting with humans and human language, it can be important to assess both the capabilities and limitations of the underlying language models.

The controller 220 may be configured to issue the control signal CS as a function of (in addition to the performance parameter Q) at least one received input data value IT and/or generated output data value OT, or a history of received input data values IT and/or generated output data values OT. Similarly, the controller may be configured to issue the control signal CS as a function of (in addition to the performance parameter Q) an external/additional control signal, which may be provided from the computation unit 210 (as indicated) or from elsewhere within the computing system 200 or even from outside the computing system 200 (as marked as “Other”). Such signals provided to the controller 220 are denoted with dashed arrows to indicate that they are optional.

In response to the control signal CS, the computation unit 210 may be operative to adjust a number of bits (i.e. the precision/accuracy) of the input data values IT or values derived therefrom that are used by the computation unit 210 in performing the operations of the LLM. The computation unit 210 may be operative to prevent or disable use of one or more least significant bits of the input data values IT or values derived therefrom from being used by the computation unit 210 in performing such operations.

As another example, where the operations comprise applying a weight value to at least one received input data value IT or value derived therefrom, the computation unit 210 may be operative to adjust a number of bits (i.e. the precision/accuracy) of the weight value used by the computation unit 210 in performing such operations. The computation unit 210 may be operative to prevent or disable use of one or more least significant bits of the weight value from being used by the computation unit in performing such operations.

As another example, where the operations comprise accumulating a plurality of received input data values IT or data values derived therefrom to generate accumulated data values, the computation unit 210 may be operative to adjust a number of bits (i.e. the precision/accuracy) of the data values which are subject to the accumulation and/or of the accumulated data values. The computation unit 210 may be operative to prevent or disable use of one or more least significant bits of the data values which are subject to the accumulation and/or of the accumulated data values.

Such control of the precision/accuracy of values used in the operations of the LLM may affect the performance metric of the LLM. For example, where the performance metric comprises perplexity, it may be that by reducing precision/accuracy the perplexity is increased. There may be use cases where it is acceptable to increase the perplexity to a degree, for example to save power. For example, where a human is interacting with an LLM in a low-importance scenario such as general social chat, a relatively high perplexity may be tolerable. Conversely, there may be use cases where it is important to reduce the perplexity, despite a potential increase in power consumption. For example, where a human is interacting with an LLM in a high-importance scenario such as seeking urgent medical advice, a relatively low perplexity may be important or even critical.

The performance parameter Q may be provided to the computing system 200 as an external signal (i.e. from outside the computing system 200) or may be generated within the computing system 200 itself. For example, the computing system 200 or an external system may be configured—in the above examples—to determine whether a low-importance scenario or high-importance scenario is underway and control the value of the performance parameter Q accordingly to reflect the level of importance of the scenario.

In some arrangements the computing system 200 (or the controller 220 or computation unit 210) may therefore be provided with an input to receive the tunable performance parameter Q separate to the series of input data values. In some arrangements the controller 220 or computation unit 210 may be configured to generate a composite tunable performance parameter based at least in part on the received tunable performance parameter. The controller 220 may be configured to issue the control signal CS as a function of the received tunable performance parameter and/or composite tunable performance parameter, and these will be generically referred to herein as tunable performance parameter Q for simplicity.

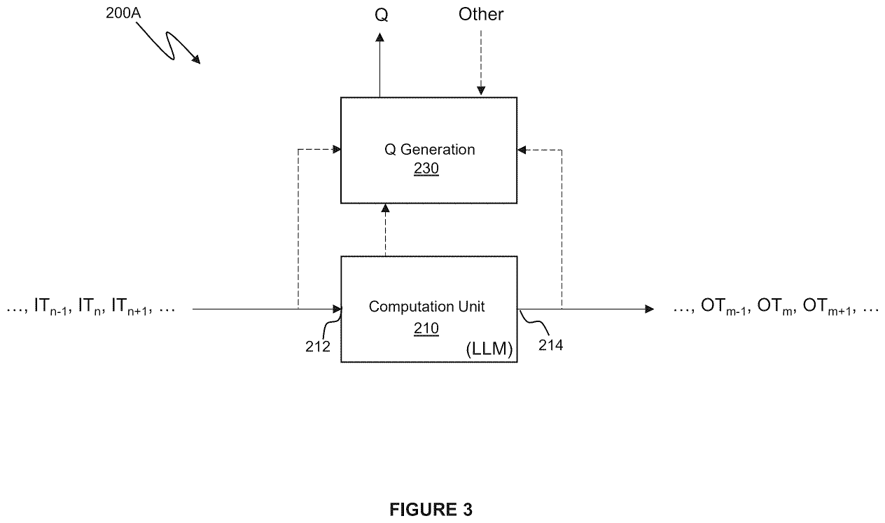

FIG. 3 is a schematic diagram of a computing system 200A embodying the present invention. The computing system 200A is a variation of the computing system 200; it includes the computation unit 210 and the controller 220, although the controller 220 is not shown in FIG. 3 itself merely to avoid complicating the Figure.

Computing system 200A differs from computing system 200 in that it additionally comprises a Q Generation unit 230 which may itself comprise digital and/or analog circuitry, such as neural network circuitry. The Q Generation unit 230, and thus the computing system 200A, is configured to generate the tunable performance parameter Q. Of course, the Q Generation unit 230 may be provided as part of the computation unit 210 or the controller 220 in some arrangements.

The Q Generation unit 230 (or the computing system 200A) is configured to generate/adjust a value of the tunable performance parameter (or composite tunable performance parameter) Q based on at least one of: at least one received input data value IT and/or generated output data value OT; a history of received input data values IT and/or generated output data values OT (these may for example contain information as to the level of importance of the scenario underway, as discussed above); at least one value of the tunable performance parameter Q; a history of values of the tunable performance parameter Q; a current time; a temperature (current or historical) of the computation unit 210; a supply voltage of the computation unit 210; a sensor signal derived from a sensor of the computing system 200A; an external/additional control signal; a user setting; a performance-related feedback signal; a level of available power supply; and a charging state of a battery (such as a battery of the computing system 200A). As before, the external/additional control signal here may be provided from the computation unit 210 (as indicated) or from elsewhere within the computing system 200A or even from outside the computing system 200A (as marked as “Other”). The provision of suitable signals to the Q Generation unit 230 in this regard is indicated in FIG. 3 by dashed arrows.

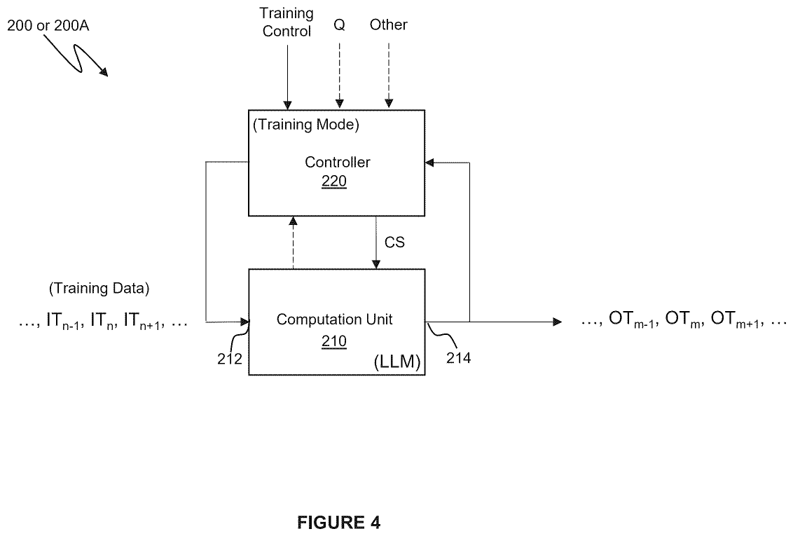

FIG. 4 is a schematic diagram representative of computing system 200 or 200A, useful for understanding how the controller 220 may be trained or configured. Where computing system 200A is taken to be represented, it will be understood that the Q Generation unit 230 is not shown for simplicity.

The controller 220 (or the computing system 200 or 200A) may be configured, in a training/configuring mode as indicated, to vary a value of the control signal CS and define the function (applied by the controller 220) based on an effect of varying the value of the control signal CS on the performance metric. Additionally or alternatively, the controller 220 (or the computing system 200 or 200A) may be configured, in a training/configuring mode as indicated, to provide the computation unit with one or more training sets of input data values IT (as indicated in FIG. 3) and define the function (applied by the controller 220) based on an effect of the one or more training sets of input data values IT on the performance metric.

Additionally or alternatively, the controller 220 (or the computing system 200 or 200A) may be configured, in a training/configuring mode as indicated, to vary a value of the tunable performance parameter Q and define the function (applied by the controller 220) based on an effect of varying the value of the tunable performance parameter Q on the performance metric. The value of the tuneable performance parameter Q may be varied by the controller 220 itself or by, in the case of computing system 200A, controlling the Q Generation unit 230 accordingly. Training/configuring by varying a value of the tunable performance parameter Q may for example enable a determination as to whether, by controlling values of the tunable performance parameter Q, a desired affect on the performance metric is achieved. The function may be adjusted until the desired affect is achieved for example.

Such training/configuring may thus comprise measuring or assessing the performance of the LLM of the computation unit 210 while varying the value or values as above, in according with the chosen performance metric.

It might for example be that the controller 220 is trained or configured so that a performance metric such as perplexity is inversely proportional (or inversely related) to the value Q, for example. In another arrangement, the controller 220 may be trained or configured so that a performance metric is proportional to (or positively correlated to) the value Q, for example. In some arrangements, the controller 220 may be trained or configured so that the value Q defines a cap or upper limit, or floor or lower limit, or range, for values of the performance metric.

In some arrangements, the function applied by the controller 220 may be implemented by way of setting values in a look-up table (LUT). That is, in the training/configuring mode, values of the look-up table may be set so that, in an operational mode, the controller 220 obtains a value or values of the control signal CS by accessing the look-up table based at least on a value or values of the tunable performance parameter Q. Successive values of the control signal CS may be obtained by accessing the look-up table based on successive values of at least the tunable performance parameter Q.

Thus, as an example, to train or configure the controller 220, the computation unit 210 (i.e. LLM) may be run and the accuracy varied with a given set of input tokens and the performance (quality) metric calculated (e.g. perplexity) as a function of the varied/reduced accuracy. This may be repeated over a variety of token sets (training sets of input data values IT) to estimate the relationship between accuracy and quality/performance as a function of the token set. The data obtained from this exercise may be used to configure the controller 220 for a given set of input data values IT and quality/performance.

Where the controller 220 is configured by way of a LUT, the LUT may be configured to be accessed based on (as inputs) the current or prior input data value IT and a value of the tunable performance (quality) parameter Q. In this example, the LUT then contains the accuracy with which the LLM calculation(s) may be performed, expressed as a value of the control signal CS, in relation to those input IT and Q values.

As mentioned, earlier, the performance metric of the computation unit 210 (in the running example, of the LLM) may comprise a perplexity or any other metric suitable for evaluating the performance/quality of an LLM (such as cross entropy loss or any other cross-entropy-related metric). Alternatively or additionally, the performance metric of the computation unit 210 may comprise one or more of: a power consumption of the computing system 200/200A or computation unit 210, a metric indicative of class discriminability of the output data values OT of the computation unit 210, a difference between the output data values OT and one or more thresholds, a measure of Kullback Leibler, KL, divergence, a statistical distance metric between output data values OT of the computation unit 210, and a mean, standard deviation, STD, skew or kurtosis of the output data values OT in comparison to typical values. These are of course examples.

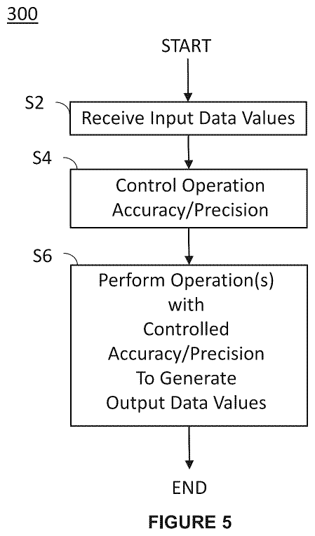

FIG. 5 is a flowchart representation of a computing method 300 which may be carried out by the computing system 200/200A. The method 300 comprises receiving (step S2), at the computation unit 210, a series of input data values IT; generating (step S6), at the computation unit 210, a series of output data values OT by performing operations on at least one received input data value IT and/or generated output data value OT; and controlling (step S4), by the controller 220 and as a function of the tunable performance parameter Q, a level of accuracy/precision of the operations (step S6) and thereby affecting a performance metric of the computation unit 210. As mentioned earlier, the tunable performance parameter Q may be received (from an external source) separately to the input data values at step S2.

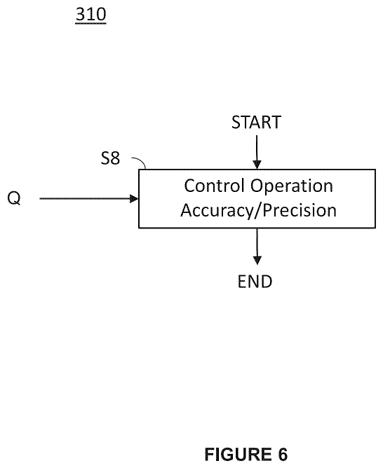

FIG. 6 is a flowchart representation of a method 310 of controlling the computation unit 210 of the computing system 200/200A. Reference may also be made to FIG. 5. The method 310 comprises controlling (step S8), as a function of the tunable performance parameter Q, a level of accuracy/precision of the operations (performed by the computation unit 210) and thereby affecting a performance metric of the computation unit 210. As mentioned in connection with FIG. 5, the tunable performance parameter Q may be received (from an external source) separately to the input data values.

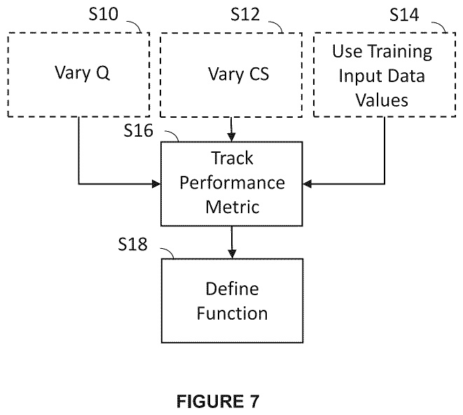

FIG. 7 is a flowchart representation of a method 320 of training/configuring the controller 210. Reference may also be made to FIG. 4. The method 320 comprises varying (step S10) a value of the tunable performance parameter Q and defining (step S18) the function (implemented by the controller 210) based on an effect (step S16) of varying the value of the tunable performance parameter Q on the performance metric; and/or varying a value of the control signal CS and defining (step S18) the function (implemented by the controller 210) based on an effect (step S16) of varying the value of the control signal CS on the performance metric; and/or providing the computation unit 210 with one or more training sets of input data values IT and defining (step S18) the function (implemented by the controller 210) based on an effect of the one or more training sets of input data values IT on the performance metric.

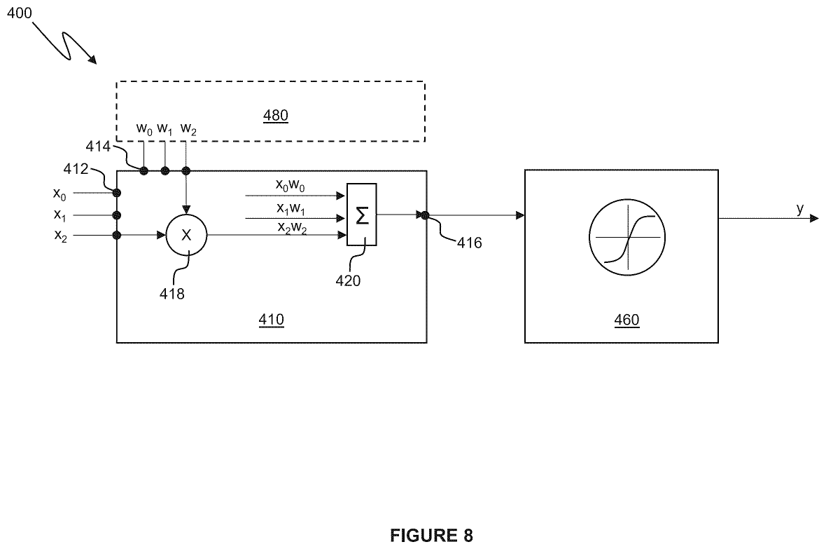

As described earlier, and continuing the LLM running example, the precision/accuracy of values used in the operations of the LLM may affect the performance metric of the LLM. To better understand how such the precision/accuracy of values may be controlled, specific detailed implementation examples will now be considered in connection with FIGS. 8 to 11, in each case considering an example neuron of the ANN involved.

FIG. 8 is a schematic diagram of an example neuron (or part thereof) 400 for an ANN which may be used to implement the LLM of the computation unit 210. The example neuron comprises a dot product engine 410 and an activation function unit 460.

A neuron of a neural network can be modelled, in part, by a vector multiplication operation, multiplying a vector of input values (representing the inputs to the neuron) by a vector of weights or coefficients (representing the weights applied by the neuron to its inputs) to generate an intermediate output value (representing the sum of the results of the multiplication of each input value with the corresponding weight value, i.e. the dot product of the input vector and the weight vector). This intermediate output value is then subjected to an activation function to provide the neuron output.

The dot product engine 410 of FIG. 8 is configured to calculate the dot product of a plurality (in this example three) of input signals and a plurality (in this example three) of weight signals, by multiplying each input with a corresponding weight and summing the results of the multiplication to generate a single output value. Thus the dot product engine implements part of the functionality of a neuron of an ANN.

To this end, the dot product engine 410 has a plurality of parallel data input terminals 412 for receiving input data signals, a plurality of weight input terminals 414 for receiving weight data signals, and a data output terminal 416 for outputting a result of a calculation of the dot product of the input data signals and the weight data signals. The input data signals here may represent example input data D and correspond to the input data values IT or values derived therefrom.

The dot product engine 410 further includes a plurality of computation elements 418 (of which, for the sake of clarity, only one is shown in FIG. 8) and a summation unit 420. The computation elements 418 may be digital computation elements or analog computation elements. In the case where the computation elements 418 are digital computation elements, the dot product engine 410 may be referred to as a digital dot product engine, whereas if the computation elements 418 are analog computation elements the dot product engine 410 may be referred to as an analog dot product engine.

In one example, the computation elements 418 may be based on memristors, in which case the weight data signals received by the dot product engine 410 via the weight input terminals 414 may be, for example, signals that are used to program the computation elements 418 with weight data. Alternatively, the computation elements may comprise other forms of non-volatile analog memory elements, for example based on floating-gate structures, or may comprise non-volatile digital memory elements used to digitally configure analog elements, for example the values of switched capacitors or the values of current sources.

As used herein the term memristor or memristive element may refer to an electronic element that has a variable resistance which can be controllably varied and which has some memory such that a particular resistance state persists in the absence of applied power. Binary memristors have been proposed, for instance based on MRAM (Magnetoresistive random-access memory) or ReRAM (Resistive random-access memory) memory, that can exhibit either a high resistance state or a low resistance state and can be selectively programmed to operate in the desired state, for instance by applying suitable programming voltages. An individual MRAM or ReRAM memory or memristor may thus be used as binary memristor and can be seen as a type of programmable memory.

However there may be other types of programmable-resistance memory component that can be selectively controlled to adopt one of two different states, where each state exhibits a different resistance or conductance, and the selected state persists once programmed. For instance programmable-resistance memory components could comprise or be based on flash-based memory e.g. floating-gate technologies such as ESF3, charge-trap technologies such as Silicon-Oxide-Nitride-Oxide-Silicon technologies (SONOS), fuses (polysilicon or metal), carbon nanotubes or some non-memristive MRAM technologies such as spintronic technology, or phase-change memory. In general, any suitable programmable-resistance memory component could be used as a binary memory component in place of at least of the some binary memristors or computation elements described in the various embodiments.

Where the computation elements 418 are digital computation elements, the weight data signals may be received from a memory 480, external to the dot product engine 410, which stores weight values, though the weight data may also be stored locally in the digital computation element.

In use of the neuron (or part thereof) 400, input data signals x₀, x₁, x₂ are received at the data input terminals 412 of the dot product engine 410. A computation element 418 of the dot product engine 410 multiplies each received input signal x₀, x₁, x₂ with a corresponding weight w₀, w₁, w₂ and outputs an output signal representing the result of the multiplication to the summation unit 420. For example, as shown in FIG. 8, a computation element 418 of the dot product engine 410 calculates the product of input signal x₂ and weight w₂ and outputs a signal representing the result x₂w₂ of this multiplication to the summation unit 420.

The summation unit 420 sums the results x₀w₀, x₁w₁, x₂w₂ of the multiplication operations performed by the computation elements 418 and outputs a dot product output signal representing the sum of the multiplication operations to the non-linear activation function 460, via the output terminal 416 of the dot product engine 410.

The non-linear activation function 460 performs a non-linear activation function on the dot product output signal. For example, the non-linear activation function unit 460 may compare the magnitude of the dot product output signal to a threshold, and output an output signal y having a magnitude equal to that of the dot product output signal if the magnitude of the dot product output signal meets or exceeds the threshold. If the magnitude of the dot product output signal is below the threshold, the non-linear activation function unit 460 may output a zero or a signal having some other constant magnitude. It will be understood that this is a simple example of a non-linear activation function, and that alternative non-linear functions may be used as required by the particular circumstances and application of the net in which the neuron 400 is used. For example, the non-linear activation function may include or be based on a non-linear function such as a cube, square, ReLU, sigmoid, tanh. Other suitable non-linear functions will be familiar to those skilled in the art.

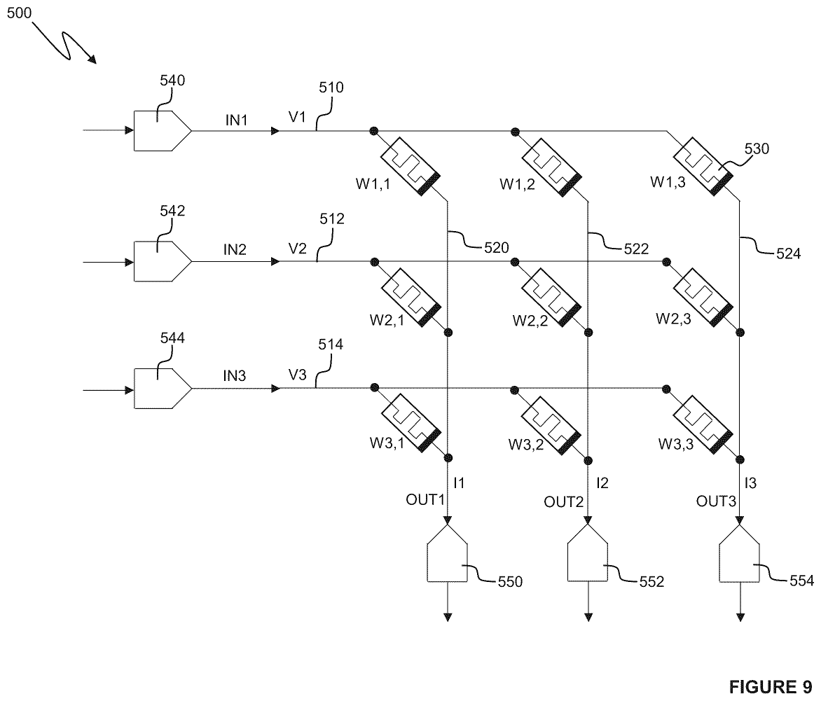

FIG. 9 is a schematic representation of a crossbar array 500 for use in an analog implementation of a neuron (or part thereof) for an ANN, e.g. the neuron (or part thereof) 400 of FIG. 8. In this example the crossbar array uses memristive elements as combined storage and computation elements (referred to hereinafter as computation elements), but it will be appreciated by those skilled in the art that alternative computation elements could be used.

The crossbar array includes a plurality (in this example three) of first electrodes (e.g. row electrodes) 510, 512, 514 and a plurality (in this example three) of second electrodes (e.g. column electrodes) 520, 522, 524 arranged to overlap with the plurality of row electrodes 510, 512, 514. Thus, the example crossbar array illustrated in FIG. 9 is a 3×3 crossbar array, though of course crossbar arrays of different dimensions are possible. Each of the row electrodes 510, 512, 514 is coupled to each of the column electrodes 520, 522, 524 via a respective computation element. In this example the computation elements are memristive elements, but it is to be appreciated that the principles described in the present disclosure are equally applicable to any combined computation and storage element, such as the programmable-resistance memory components discussed above.

To programme the crossbar array 500, programming voltage pulses may be applied to the column electrodes 520, 522, 524 while a write voltage is applied to one of the row electrodes (e.g. row electrode 510) so as to create a resultant voltage to program the resistance state of each of the memristive elements 530 of that row. The other row electrodes (e.g. row electrodes 512, 514) may be held at a voltage level such that the resultant voltage experienced by the memristive elements of these other rows is insufficient to change the resistance state of the memristive element. The crossbar array 500 may be programmed in this way, row by row. Once programmed, the memory can be read out, row by row, by applying a read pulse to the relevant row and monitoring each column to determine the resistance state of the relevant memristive elements.

Once suitably programmed the crossbar array 500 can be used to perform computation operations.

The row electrodes 510, 512, 514 are arranged as inputs IN1, IN2, IN3 and the column electrodes 520, 522, 524 are arranged as outputs OUT1, OUT2, OUT3. It will be understood however that the principle could apply to a different number of inputs and/or outputs and the number of inputs could be different to the number of outputs. Each input is connected to each output via a respective memristive element 530.

In the example of FIG. 9, input data may be provided to each input of the array as a respective voltage level, V1, V2, V3. Each output will provide a respective output current 11, 12, 13. A given output will receive a contribution of current from each input, where the respective current contribution depends on the respective voltage at that input and the resistance state of the relevant memristive element. Simplistically, if each output were considered to be held at ground or be a virtual earth, the current contribution at a given output k from a given input j will be equal to the voltage Vj at input j multiplied by the conductance Gj,k of the memristive element linking input j to output k (and where the conductance Gj,k is the inverse of the resistance of the relevant memristive element, i.e. Gj,k=1/Rj,k where Rj,k is the resistance of the relevant memristive element). In this example a given output thus receives a contribution to the overall current output current from each input, where the current contribution is equal to the product of the voltage at that input and the conductance of the relevant memristive element. The overall current output may be regarded as representing the dot product Gk.V=Σ Gj,k.Vj of a vector V comprising the set of voltages Vj with a vector Gk comprising the set of conductances {Gj,k; j=1 . . . }.

The conductance Gj,k of the memristive element, i.e. 1/Rj,k, can thus be seen as a weight Wj,k applied to the data at input j for output k. If suitable data is applied simultaneously to multiple inputs, the output current at a given output is a sum of the weighted contributions from the various inputs. This output current could be processed as an analogue current variable or converted into a corresponding voltage. It can therefore be seen that the crossbar array illustrated in FIG. 9 performs simultaneous dot product calculations for the various input data values with stored weight values, without requiring a separate memory read process and automatically provides a sum of the relevant weighted input values for a given output.

In some applications input data on which computation operations are to be performed by the crossbar array 500 may be provided as digital signals, and digital output signals representing the results of the computations performed by the crossbar array may be desired. Thus, a system in which the crossbar array 500 is employed may include a plurality of digital to analog converters (DACs) 540, 542, 544, each configured to receive a digital input data signal and to output an analog representation of the received digital input signal to an input IN1, IN2, IN3 of the crossbar array 500. Each output OUT1, OUT2, OUT3 of the crossbar array 500 may be coupled to one of a plurality of analog to digital converters (ADC) 550, 552, 554, each ADC being configured to convert an analog output signal of the crossbar array 500 into a digital representation of the analog output signal.

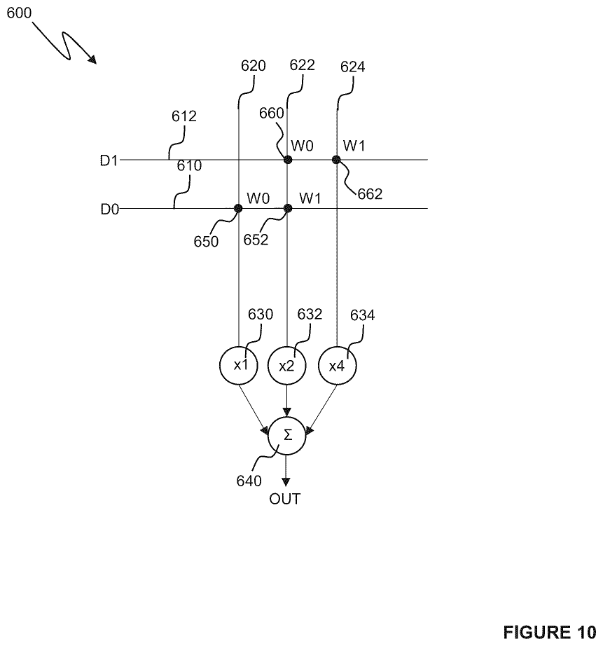

FIG. 10 schematically illustrates the multiplication of a 2-bit data input D by a 2-bit weight W using a crossbar array that implements m-ary arithmetic.

For the purposes of illustration, the crossbar array, shown generally at 600 in FIG. 10, is shown as including first and second row electrodes 610, 612 and first, second and third column electrodes 620, 622, 624. First, second and third multipliers 630, 632, 634 are coupled to output terminals of the first, second and third column electrodes 620, 622, 624 respectively, and are configured to apply binary weighting factors to the partial products output at the output terminals of the column electrodes 620, 622, 624. Thus in this example the first multiplier 630 is configured to multiply the partial product output at the output terminal of the first column electrode 620 by 1, the second multiplier 632 is configured to multiply the partial product output at the output terminal of the second column electrode 622 by 2, and the third multiplier 634 is configured to multiply the partial product output at the output terminal of the third column electrode 620 by 4. A summation unit 640 is coupled to outputs of the multipliers 630, 632, 634 and is configured to output the sum of the outputs of the multipliers 630, 632, 634.

It will be understood that the multipliers 630,632,634 may comprise any suitable system for the multiplication of an input signal, for example a switched capacitor summation network with ratioed capacitors; a scaled or ratioed current mirror network; a passive resistor network such as an R2R ladder; or an op-amp based circuit. It will be further understood that the multipliers may be structurally merged with ADCs, summation units, or accumulators as provided in the system.

The first and second row electrodes 610, 612 receive the constituent bits of the data input D in parallel. In the illustrated example the first row electrode 610 receives a least significant bit D0 of the data input D and the second row electrode 612 receives a most significant bit D1 of the data input D.

Computation elements of the crossbar array 600 are programmed with the constituent bits of the weight W. Thus, a computation element 650 at the intersection of the first row electrode 610 and the first column electrode 620 is programmed with a least significant bit W0 of the weight W, such that the first column electrode 620 outputs the partial product D0.W0. A computation element 652 at the intersection of the first row electrode 610 and the second column electrode 622 is programmed with a most significant bit W1 of the weight W, whilst a computation element 660 at the intersection of the second row electrode 612 and the second column electrode 622 is programmed with a least significant bit W0 of the weight W. Thus, the second column electrode 622 outputs the sum of the partial products D0.W1 and D1.W0. A computation element 662 at the intersection of the second row electrode 612 and the third column electrode 624 is programmed with a most significant bit W1 of the weight W, such that the third column electrode 624 outputs the partial product D1.W1.

The outputs of the column electrodes 620, 622, 624 are multiplied by the binary weighting factors of the multipliers 630, 632, 634 and the summation unit 640 calculates the sum of the outputs of the multipliers 630, 632, 634 to generate an output.

For example, if the weight W is 2 (=1 0 in binary) and the data input D is 2 (=1 0 in binary), then D0=0 and D1=1, and W0=0 and W1=1. The partial product D0.W0 calculated by the computation element 650 and output by the first column electrode 620 is therefore equal to 0, and is multiplied by 1 by the first multiplier 630, which therefore outputs a signal with a value 0. The sum of the partial product D0.W1 calculated by the computation element 652 and the partial product D1.W0 calculated by the computation element 660, which is output by the second column electrode 622 is also equal to 0, and is multiplied by 2 by the second multiplier 632, which therefore also outputs a signal with a value 0. The partial product D1.W1 calculated by the computation element 662 and output by the third column electrode 624 is equal to 1, and is multiplied by 4 by the third multiplier 634, which therefore outputs a signal with a value 4.

The summation unit calculates the sum of the outputs of the multipliers 630, 632, 634, as (0+0+4)=4.

For the purpose of illustration the crossbar array 600 is shown as having only two row electrodes and only three column electrodes, but it will be appreciated that a practical implementation of a crossbar array for use in an analog computing system for an artificial neural network will have significantly more row and column electrodes and associated computation elements and multipliers, since the computation operations performed by the crossbar array will typically involve weights and data of greater than two-bit values.

Thus, a practical implementation of a crossbar array of the kind illustrated in FIG. 10 requires a significant number of computation elements and multipliers, and therefore may occupy a significant area of silicon on an integrated circuit and may consume a significant amount of power.

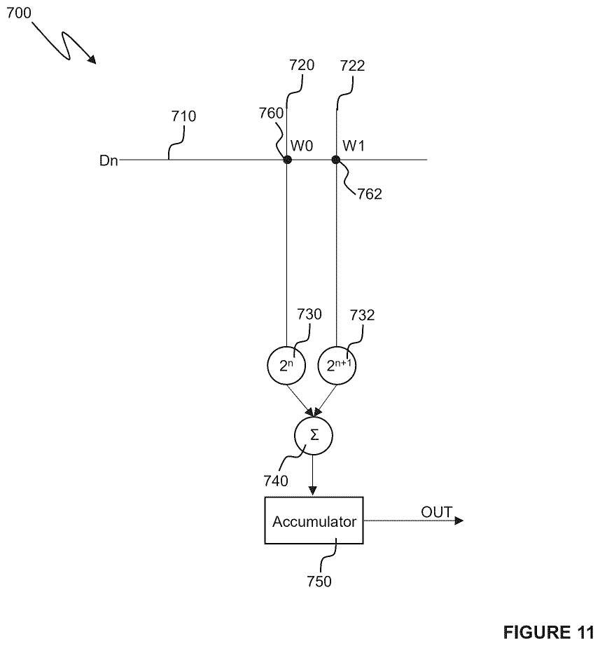

A more efficient (in terms of silicon area and power consumption) crossbar array for performing a multiplication of an input D with a two bit weight W is illustrated schematically in FIG. 11.

This crossbar array (shown generally at 700) includes a single row electrode 710 and first and second column electrodes 720, 722. First and second multipliers 730, 732 are coupled to the outputs of the first and second column electrodes 720, 722 respectively, and a summation unit 740 is coupled to outputs of the multipliers 730, 732. The summation unit 740 is configured to output the instantaneous sum of the outputs of the multipliers 730, 732 to an accumulator 750, which accumulates the outputs of the summation unit 740 over a predetermined time period required to process all of the bits of the input data to generate an output value representing the multiplication of the value of the data input D and the value of the weight W.

A first computation element 760 is provided at the intersection of the row electrode 710 with the first column electrode 720, whilst a second computation element 762 is provided at the intersection of the row electrode 710 with the second column electrode 722.

In use of the crossbar array 700, the first and second computation elements 760, 762 are programmed with a least significant bit W0 and a most significant bit W1 of the weight W, and the constituent bits of the data input D are input to the row electrode 710 as a time-sequenced bitstream (e.g. synchronised with a clock signal). Thus, where the data input is a two-bit value, at a time point t=0 a least significant bit D0 is input to the row electrode 710, and at a subsequent time point t=1 a most significant bit D1 is input to the row electrode 710. More generally, at a time point t=n, a bit Dn of the input data D is input to the row electrode 710.

The binary weighting factors applied by the first and second multipliers 730, 732 are also time sequenced, and are dependent upon which bit in the bitstream of the input D is being input to the row electrode 710. Thus, the binary weighting factor applied by the first multiplier 730 at a time point t=n is equal to 2ⁿ, whilst the binary weighting factor applied by the second multiplier 732 at the time point t=n is equal to 2ⁿ⁺¹.

The table below shows the value of the input data bit Dn, the partial products calculated by the computation units 760, 762, the outputs of the multipliers 730, 732, the output of the summation unit and the value stored in the accumulator over time in the example where the input data is 2 (binary value 1 0) and the weight is also 2 (binary value 1 0).

| Time | | | | First | Second | Summation | Accumulator |
|---|---|---|---|---|---|---|---|
| point | Dn | Dn · W0 | Dn · W1 | multiplier o/p | multiplier o/p | unit o/p | value |
| 0 | 0 | 0 | 0 | 0 | 0 | 0 | 0 |
| 1 | 1 | 0 | 1 | 0 | 4 | 4 | 4 |

Thus, at the end of the predetermined time period required to process all of the bits of the input data, the accumulator 750 outputs a value 4, representing the multiplication of the value of the data input D and the value of the weight W.

The control signal CS output by the controller 220 (see FIG. 2) may, for example, cause the computation unit 210 to adjust the number of bits of the input data D that are processed by the computation unit 210. For example, if a relatively lower accuracy output from the computation unit 210 is acceptable the controller 220 may output the control signal CS to cause the computation unit 210 not to process the least significant bits (e.g. the least significant 4, 2 or 1 bits) of the input data D. Similarly, if a relatively higher accuracy output is required the controller may output the control signal CS to cause the computation unit 210 to process some or all of the least significant bits of the input data D.

If the computation unit 210 is based on one or more crossbar arrays 400 of the kind described above with reference to FIG. 10, then in response to the control signal CS the computation unit 210 may, for example, disable one or more row electrodes 610, 612, (e.g. by opening one or more row electrode switches to decouple the relevant row electrode(s) from the data input(s)) so as to prevent the least significant bit(s) of the input data D from being used in the computation of the output of the computation unit 210, thereby providing a relatively reduced accuracy output. Alternatively, if a relatively higher accuracy output is required, then in response to the control signal CS the computation unit 210 may, for example, (re)-enable the relevant row electrode(s) 610, 612 so as to ensure that the relevant bits of the input data D are used in the computation of the output of the computation unit 210.

Alternatively, if the computation unit 210 is based on one or more crossbar arrays 700 of the kind described above with reference to FIG. 11, the computation unit 210 may, in response to the control signal CS from the controller 520, disable the row electrode 710 (e.g. by opening a row electrode switch to decouple the row electrode 710 from the data input), the accumulator 750 (e.g. by decoupling the input of the accumulator 750 from the output of the summation unit 740, or by decoupling the output of the accumulator 750 from the output of the computation unit, using appropriate switches), or both, for a predetermined period of time, so as to ensure that the least significant bits (e.g. the least significant 4, 2 or 1 bits) of the input data are not taken into account when computing the output of the computation unit 210. Alternatively, if a relatively higher accuracy output is required, then in response to such control signals the computation unit 210 may, for example, (re)-enable the row electrode 710 and/or the accumulator 750 so as to ensure that the relevant bits of the input data D are used in the computation of the output of the computation unit 210.

Additionally or alternatively, the control signal CS output by the controller 220 may cause the computation unit 210 to adjust the number of bits of the weight W that are processed by the computation unit 210. For example, if a relatively lower accuracy output from the computation unit 510 is acceptable the controller 220 may output one or more control signals to cause the computation unit 210 not to use the least significant bits (e.g. the least significant 4, 2 or 1 bits) of the weight W. Similarly, if a relatively higher accuracy output is required the controller may output one or more control signals to cause the computation unit 210 to process some or all of the least significant bits of the weight W.

If the computation unit 210 is based on one or more crossbar arrays 600 of the kind described above with reference to FIG. 10, then in response to the control signal CS the computation unit 210 may, for example, disable one or more of the column electrodes 620, 622 (e.g. by opening one or more column electrode switches to decouple the relevant column electrode(s) from the corresponding multiplier) so as to prevent the least significant bit(s) of the weight W from being used in the computation of the output of the computation unit 210, thereby providing a relatively reduced accuracy output. Alternatively, if a relatively higher accuracy output is required, then in response to the control signal CS the computation unit 210 may, for example, (re)-enable the relevant column electrode(s) 620, 622 so as to ensure that the relevant bits of the input data D are used in the computation of the output of the computation unit 210.

Alternatively, if the computation unit 210 is based on one or more crossbar arrays 700 of the kind described above with reference to FIG. 11, the computation unit 510 may, in response to the control signal CS from the controller 220, disable the first column electrode 720 (e.g. by opening a column electrode switch to decouple the first column electrode 720 from the first multiplier 730) so as to ensure that the least significant bit of the weight W is not used in the computation of the output of the computation unit 210, thereby providing a relatively reduced accuracy output. Alternatively, if a relatively higher accuracy output is required, then in response to the control signal CS the computation unit 210 may, for example, (re)-enable the first column electrode 720 so as to ensure that the least significant bit of the weight W is used in the computation of the output of the computation unit 210.

Additionally or alternatively, the control signal CS output by the controller 220 may cause the computation unit 210 to adjust the number of bits that are output by the computation unit 210. For example, if a relatively lower accuracy output from the computation unit 210 is acceptable the controller 220 may output the control signal CS to cause the computation unit 210 to output only the most significant bits (e.g. the most significant 4, 2 or 1 bits) of the value output by the summation unit 640 (for a computation unit based on the crossbar array 600 of FIG. 10) or accumulator 750 (for a computation unit 210 based on the crossbar array 700 of FIG. 11). Similarly, if a relatively higher accuracy output is required the controller 220 may output the control signal CS to cause the computation unit 210 to output some or all of the least significant bits of the value output by the summation unit 640 or accumulator 750, in addition to the most significant bits.

Thus, considering the above in terms of multiply-accumulate (MAC) or multiply-add (MAD) functionality, there are various ways to control the accuracy/precision within ANN circuitry. It is also worth noting that such control can be carried out while maintaining low latency. Firstly, accuracy of the weights can be controlled. This adjustment can be achieved through the deactivation of specific bit lines connected to the memory, resulting in a retrieval of a diminished bit sequence for the multiplication process. Alternatively, employing a bit-series methodology could serve the same purpose. Secondly, accuracy of the data can be controlled. The strategy applied to the modification of weight precision is equally applicable here, facilitating a tailored approach to accuracy. Thirdly, accuracy of the accumulation can be controlled. To conserve energy, this method involves deactivating the lower bits of the accumulator, thereby reducing its precision without compromising the overall system performance.

One possible analogue implementation is via a resistor array. The data may be applied in a bit serial manner or a PWM manner. In both cases the data may be serialised into the array. To reduce data accuracy, the operation may be started with the MSB and proceed with each successive lower-order bit in turn until the desired accuracy has been achieved. The output can have its accuracy reduced by turning down the performance of the ADC (analog-to-digital converter) measuring the output. This may be achieved by turning down the bias of the ADC, reducing the order of the ADC (e.g. assuming a sigma-delta topology), and/or reducing the conversion time (e.g. assuming a pipeline ADC). Again these are just example implementations.

It will be understood that the computing system 200/200A, or any of the computation unit 210, controller 220 and Q Generation unit 230, may be implemented as, or as part of, an integrated circuit such as an IC chip. As mentioned earlier, the computing system 200/200A may be understood to be, or be part of, a (electrical or electronic) device such as a mobile telephone, a tablet or laptop computer or an Internet of Things (IoT) device or the like.

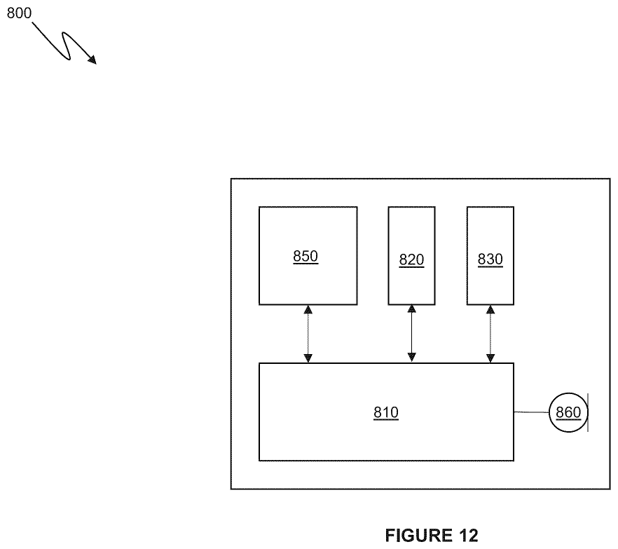

FIG. 12 is a schematic representation of such a device 800. The device 800 may be an edge device such as a mobile telephone, tablet or laptop computer, IoT device or the like.

The device 800 includes a processing unit 810, embodied on one or more integrated circuits, which may be, for example, an application processor. The device further includes memory 820 communicatively coupled to the processing unit 810, and a communications subsystem 830 which is also communicatively coupled to the processing unit 810 to permit the device 800 to communicate with systems and devices external to the device 800. The device further includes an integrated circuit 850 that implements a computing system 200/200A of the kind described above. A digital or analog microphone or other audio capture device or subsystem 860 may also be provided, coupled to the processing unit 810 to provide audio data to the processing unit 810. For example, the input data values described herein may be, or be derived from, audio data. Similarly, the output data values described herein may be generated as audio data, for example to be output via a speaker (not shown). The integrated circuit 850 is communicatively coupled to the processing unit 810 for receiving input data from and transmitting output data to the processing unit 810.

By way of summary, the energy demands of LLM inference (as an example use case following the running example presented herein) are substantial and increasing with model complexity. LLMs process sequences of tokens, which can represent full or partial words, to predict subsequent tokens. Traditional approaches to reduce computational energy involve pruning tokens, however it can be seen here in that further efficiencies can be achieved by varying the computational precision for different tokens, such as based on their likelihood of correctly predicting the next token with a reduced accuracy. The techniques disclosed herein propose using an offline-trained predictor (controller 220) to adjust computational precision dynamically, offering significant energy savings while maintaining a model accuracy as specified by the quality metric Q.

In further detail, not every token necessitates the same level of computational precision for accurate next-token prediction. LLMs function by determining the most probable subsequent token based on a given token sequence. For instance, certain scenarios may exhibit a token with a markedly higher likelihood of being the next token. Consequently, computing this prediction with reduced precision could still yield the correct outcome without compromising model accuracy.

Deploying the offline-trained predictor (controller 220) to estimate the necessary computational precision for specific tokens or token sequences leads to substantial energy savings while maintaining a desired/acceptable level of accuracy. This approach allows for computational adjustments where a clear next token exists, enabling significant reductions in energy consumption.

The quality parameter Q may be employed to cap the performance of the LLM, thus saving power. Perplexity has been considered as a suitable measure performance metric for the LLM, a measure derived from cross-entropy that assesses a model's predictive uncertainty. Perplexity, calculated as the exponential of cross-entropy loss (a log of the cross-entropy loss), effectively translates the average log-probability per word into an easily understandable metric. A lower perplexity indicates a more accurate model at predicting the next word in a sequence, thus reflecting superior performance. Perplexity not only provides insight into a model's ability to predict unseen data but also serves as a vital benchmark for evaluating language model efficiency. In the context of adjusting computational accuracy for LLMs, the notion of a perplexity ratio is introduced. This ratio compares the perplexity of the system at its current accuracy to that of a system operating at full accuracy, offering a nuanced perspective on performance trade-offs. Of course, perplexity or any other cross-entropy-relative metric may be a suitable measure performance metric for the LLM.

Statistical distance is another valuable metric for assessing LLMs, though it fulfils a distinct role compared to perplexity. It quantifies the similarity between two probability distributions, such as the Kullback-Leibler (KL) divergence, Jensen-Shannon divergence, and total variation distance, providing insights into the divergence between the actual data distribution and the model's predictions. Specifically, the KL divergence is particularly pertinent for evaluating the impact of reduced computational precision on LLMs, as it measures the discrepancy between the token distribution at full accuracy and that at reduced accuracy.

It will be recognised that a hardware-based approach performed at inference is proposed here. It is possible to dynamically adjust the precision of calculations done at the hardware level (i.e. in silicon) based on the dynamically-generated prediction of outputs. That is, for some tokens/sequences, the next output(s) can be relatively easily selected, due to say a high prediction score. For such calculations, full-precision operations are not needed to generate the next output, so it is possible to reduce the processing performed by the model to generate the output. Reduced processing here may correspond to reducing the bit-width of calculations performed by the model as discussed in more detail earlier. In this way, the system can be allowed to be more “loose” or relaxed in generating outputs by controlled the value of the tunable performance parameter Q, enabling reduced power requirements of the inference engine (computation unit 210) itself. The tunable performance parameter Q (quality factor) may be adjusted based on any number of factors, e.g. available power, importance of task, and so on.

Although a hardware-based approach is proposed, the skilled person will recognise that related benefits may be provided in a software implementation. For example, a reduction in bit lengths processed may be realised in software. The skilled person will recognise that some aspects of the above-described apparatus (circuitry), devices and methods may be embodied as processor control code, for example on a non-volatile carrier medium such as a disk, CD- or DVD-ROM, programmed memory such as read only memory (Firmware), or on a data carrier such as an optical or electrical signal carrier. For example, any of the haptic drivers 110 and 110M may be implemented as a processor operating based on processor control code. “Non-transitory” computer-readable media may be taken to comprise all computer-readable media, with the sole exception being a transitory, propagating signal.

For some applications, such aspects will be implemented on a DSP (Digital Signal Processor), ASIC (Application Specific Integrated Circuit) or FPGA (Field Programmable Gate Array). Thus the code may comprise conventional program code or microcode or, for example, code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL. As the skilled person will appreciate, the code may be distributed between a plurality of coupled components in communication with one another. Where appropriate, such aspects may also be implemented using code running on a field-(re) programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in the claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be understood—especially by those having ordinary skill in the art with the benefit of this disclosure—that the various operations described herein, particularly in connection with the figures, may be implemented by other circuitry or other hardware components. The order in which each operation of a given method is performed may be changed, and various elements of the systems illustrated herein may be added, reordered, combined, omitted, modified, etc. It is intended that this disclosure embrace all such modifications and changes and, accordingly, the above description should be regarded in an illustrative rather than a restrictive sense.

Similarly, although this disclosure makes reference to specific embodiments, certain modifications and changes can be made to those embodiments without departing from the scope and coverage of this disclosure. Moreover, any benefits, advantages, or solutions to problems that are described herein with regard to specific embodiments are not intended to be construed as a critical, required, or essential feature or element. Further embodiments likewise, with the benefit of this disclosure, will be apparent to those having ordinary skill in the art, and such embodiments should be deemed as being encompassed herein.

To aid the Patent Office (USPTO) and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

The present disclosure extends to the following statements:

S1. A computing system comprising:
a computation unit configured to receive a series of input data values and generate a series of output data values by performing operations on at least one received input data value and/or generated output data value;
an input to receive a tunable performance parameter separate to the series of input data values; and
a controller,
wherein the controller is configured, as a function of the received tunable performance parameter, to issue a control signal to the computation unit to control a level of accuracy of the operations (and optionally thereby affect a performance metric of the computation unit).
   S2. The computing system according to statement S1, wherein the computation unit comprises digital and/or analog neural network circuitry.
   S3. The computing system according to statement S1 or S2, wherein the computation unit comprises a generative pre-trained transformer.
   S4. The computing system according to any of the preceding statements, wherein the computation unit is configured to operate as a Large Language Model, or LLM, wherein the input data values are, or are part of, input tokens of the LLM and wherein the output data values are, or are part of, output tokens of the LLM.
   S5. The computing system according to any of the preceding statements, configured to generate a composite tunable performance parameter based at least in part on the received tunable performance parameter, optionally wherein the controller is configured to issue the control signal as a function of the composite tunable performance parameter.
   S6. The computing system according to statement S5, configured to adjust a value of the composite tunable performance parameter based on at least one of:
at least one received input data value and/or generated output data value;
a history of received input data values and/or generated output data values;
at least one value of the tunable performance parameter, such as a current or historical value of the tunable performance parameter;
a history of values of the tunable performance parameter;
a current time;
a temperature of the computation unit;
a supply voltage of the computation unit;
a sensor signal derived from a sensor of the computing system;
an external control signal;
a user setting;
a performance-related feedback signal;
a level of available power supply; and/or
a charging state of a battery.
   S7. The computing system according to any of the preceding statements, wherein said function is a function of at least one of:
at least one received input data value and/or generated output data value;
a history of received input data values and/or generated output data values;
at least one value of the received (or composite) tunable performance parameter, such as a current or historical value of the tunable performance parameter;
a history of values of the received (or composite) tunable performance parameter; and/or
an external control signal provided to the controller.
   S8. The computing system according to any of the preceding statements, wherein the controller is configured, in a training/configuring mode, to:
vary a value of the control signal and define said function based on an effect of varying the value of the control signal on the performance metric; and/or
provide the computation unit with one or more training sets of input data values and define said function based on an effect of the one or more training sets of input data values on the performance metric; and/or
vary a value of the tunable performance parameter and define said function based on an effect of varying the value of the tunable performance parameter on the performance metric.
   S9. The computing system according to any of the preceding statements, wherein the controller comprises a look-up table and is configured to obtain a value of the control signal by accessing the look-up table based at least on a value of the tunable performance parameter.
   S10. The computing system according to any of the preceding statements, wherein the performance metric comprises at least one of:
perplexity or cross entropy loss or any other cross-entropy-related metric;
Bilingual Evaluation Understudy, or BLEU;
Recall-Oriented Understudy for Gisting Evaluation, or ROUGE;
a power consumption of the computing system;
a metric indicative of class discriminability of the output data values of the computation unit;
a difference between the output data values and one or more thresholds; Kullback Leibler, or KL, divergence;
a statistical distance metric between output data values of the computation unit; and/or
a mean, standard deviation, or STD, skew or kurtosis of the output data values in comparison to typical values.
   S11. The computing system according to any of the preceding statements, wherein in response to the control signal the computation unit is operative to adjust a number of bits of the input data values or values derived therefrom that are used by the computation unit in performing said operations.
   S12. The computing system according to statement S11, wherein the computation unit is operative to prevent or disable use of one or more least significant bits of the input data values or values derived therefrom from being used by the computation unit in performing said operations.
   S13. The computing system according to any of the preceding statements, wherein said operations comprise applying a weight value to at least one received input data value or value derived therefrom and wherein the computation unit is operative to adjust a number of bits of the weight value used by the computation unit in performing said operations.
   S14. The computing system according to statement S13, wherein the computation unit is operative to prevent or disable use of one or more least significant bits of the weight value from being used by the computation unit in performing said operations.
   S15. The computing system according to any of the preceding statements, wherein said operations comprise accumulating a plurality of received input data values or data values derived therefrom to generate accumulated data values, and wherein the computation unit is operative to adjust a number of bits of the data values which are subject to the accumulation and/or of the accumulated data values.
   S16. The computing system according to statement S15, wherein the computation unit is operative to prevent or disable use of one or more least significant bits of the data values which are subject to the accumulation and/or of the accumulated data values.
   S17. The computing system according to any of the preceding statements, wherein the computation unit comprises a crossbar array, and wherein the crossbar array is configured to perform parallel computation on bits of the input data values or values derived therefrom, or to perform computation on bits of the input data values or values derived therefrom sequentially.
   S18. The computing system according to statement S17, wherein the crossbar array comprises:
a plurality of row electrodes, each of the plurality of row electrodes having a respective input terminal;
a plurality of column electrodes, each of the plurality of column electrodes having a respective output terminal; and
a plurality of computation elements,
wherein each of the plurality of computation elements is coupled to one of the plurality of row electrodes and to one of the plurality of column electrodes, and is configured to output a signal representative of the product of a value of a signal received at the input terminal of the row electrode to which it is coupled and a weight value associated with the computation element,
and wherein in response to receiving a control signal from the controller to reduce the level of accuracy of the operations the computation unit is operative to:
disable one or more of the row electrodes; or
disable one or more of the column electrodes.
   S19. The computing system according to statement S17 or S18, wherein the crossbar array further comprises:
a plurality of multipliers, each of the plurality of multipliers having an input coupled to the output terminal of a respective one of the plurality of column electrodes; and
a summation unit coupled to outputs of the plurality of multipliers, the summation unit being operative to output a signal representing a sum of values represented by the outputs of the plurality of multipliers,
wherein each of the plurality of multipliers is configured to apply a binary weighting to a signal received at its input and to output a binary weighted signal to the summation unit.
   S20. The computing system according to statement S17, wherein the crossbar array comprises:
a row electrode having an input terminal;
a plurality of column electrodes, each of the plurality of column electrodes having a respective output terminal; and
a plurality of computation elements,
wherein each of the plurality of computation elements is coupled to the row electrode and to one of the plurality of column electrodes, and is configured to output a signal representative of the product of a value of a signal received at the input terminal of the row electrode and a weight value associated with the computation element,
and wherein in response to receiving a control signal from the controller to reduce the level of accuracy of the operations the computation unit is operative to:
disable the row electrode for a predetermined period of time; or
disable one or more of the column electrodes for a predetermined period of time.
   S21. The computing system according to statement S20, wherein the crossbar array further comprises:
a plurality of multipliers, each of the plurality of multipliers having an input coupled to the output terminal of a respective one of the plurality of column electrodes; and
a summation unit coupled to outputs of the plurality of multipliers, the summation unit being operative to output a signal representing a sum of values represented by the outputs of the plurality of multipliers; and
an accumulator coupled to an output of the summation unit;
wherein each of the plurality of multipliers is configured to apply a binary weighting to a signal received at its input and to output a binary weighted signal to the summation unit.
   S22. The computing system according to any of the preceding statements, wherein the computation unit is a digital computation unit configured to perform bit-series computation of bits of the input data values or values derived therefrom.
   S23. An integrated circuit comprising a computing system according to any of the preceding statements.
   S24. A device comprising an integrated circuit according to statement S23, optionally wherein the device is a mobile telephone, a tablet or laptop computer or an Internet of Things (IoT) device.
   S25. A computing method comprising:
receiving, at a computation unit of a computing system, a series of input data values;
receiving, at an input of the computing system, a tunable performance parameter separate to the series of input data values,
generating, at the computation unit, a series of output data values by performing operations on at least one received input data value and/or generated output data value; and
controlling, by a controller of the computing system and as a function of the received tunable performance parameter, a level of accuracy of the operations and thereby affecting a performance metric of the computation unit.
   S26. A method of controlling a computation unit, the computation unit configured to receive a series of input data values and generate a series of output data values by performing operations on at least one received input data value and/or generated output data value, the method comprising:
controlling, as a function of a received tunable performance parameter, a level of accuracy of the operations and thereby affecting a performance metric of the computation unit.
   S27. A method of training/configuring a controller of a computing system comprising a computation unit and said controller, the computation unit configured to receive a series of input data values and generate a series of output data values by performing operations on at least one received input data value and/or generated output data value, the controller configured, as a function of a tunable performance parameter, to issue a control signal to the computation unit to control a level of accuracy of the operations and thereby affect a performance metric of the computation unit, the method comprising:
varying a value of the tunable performance parameter and defining said function based on an effect of varying the value of the tunable performance parameter on the performance metric; and/or
varying a value of the control signal and defining said function based on an effect of varying the value of the control signal on the performance metric; and/or
providing the computation unit with one or more training sets of input data values and defining said function based on an effect of the one or more training sets of input data values on the performance metric.
   S28. A computer program which, when executed on one or more processors of a computing system, causes the computing system to carry out the method of any of statements S25 to S27.
   S29. A non-transitory computer readable storage medium having the computer program of statement S28 stored thereon.
   S30. A computing system comprising:
a computation unit configured to receive a series of input data values and generate a series of output data values by performing operations on at least one received input data value and/or generated output data value; and
a controller,
wherein the controller is configured, as a function of a tunable performance parameter, to issue a control signal to the computation unit to control a level of accuracy of the operations (and optionally thereby affect a performance metric of the computation unit).

1. A computing system comprising:
a computation unit configured to receive a series of input data values and generate a series of output data values by performing operations on at least one received input data value and/or generated output data value;
an input to receive a tunable performance parameter separate to the series of input data values; and
a controller,
wherein the controller is configured, as a function of the received tunable performance parameter, to issue a control signal to the computation unit to control a level of accuracy of the operations and thereby affect a performance metric of the computation unit.

2. The computing system according to claim 1, wherein the computation unit comprises digital and/or analog neural network circuitry.

3. The computing system according to claim 1, wherein the computation unit comprises a generative pre-trained transformer.

4. The computing system according to claim 1, wherein the computation unit is configured to operate as a Large Language Model, or LLM, wherein the input data values are, or are part of, input tokens of the LLM and wherein the output data values are, or are part of, output tokens of the LLM.

5. The computing system according to claim 1, configured to generate a composite tunable performance parameter based at least in part on the received tunable performance parameter, optionally wherein the controller is configured to issue the control signal as a function of the composite tunable performance parameter.

6. The computing system according to claim 5, configured to adjust a value of the composite tunable performance parameter based on at least one of:
at least one received input data value and/or generated output data value;
a history of received input data values and/or generated output data values;
at least one value of the tunable performance parameter, such as a current or historical value of the tunable performance parameter;
a history of values of the tunable performance parameter;
a current time;
a temperature of the computation unit;
a supply voltage of the computation unit;
a sensor signal derived from a sensor of the computing system;
an external control signal;
a user setting;
a performance-related feedback signal;
a level of available power supply; and/or
a charging state of a battery.

7. The computing system according to claim 1, wherein said function is a function of at least one of:
at least one received input data value and/or generated output data value;
a history of received input data values and/or generated output data values;
at least one value of the received tunable performance parameter, such as a current or historical value of the tunable performance parameter;
a history of values of the received tunable performance parameter; and/or
an external control signal provided to the controller.

8. The computing system according to claim 1, wherein the controller is configured, in a training/configuring mode, to:
vary a value of the control signal and define said function based on an effect of varying the value of the control signal on the performance metric; and/or
provide the computation unit with one or more training sets of input data values and define said function based on an effect of the one or more training sets of input data values on the performance metric; and/or
vary a value of the tunable performance parameter and define said function based on an effect of varying the value of the tunable performance parameter on the performance metric.

9. The computing system according to claim 1, wherein the controller comprises a look-up table and is configured to obtain a value of the control signal by accessing the look-up table based at least on a value of the tunable performance parameter.

10. The computing system according to claim 1, wherein the performance metric comprises at least one of:
perplexity or cross entropy loss or any other cross-entropy-related metric;
Bilingual Evaluation Understudy, or BLEU;
Recall-Oriented Understudy for Gisting Evaluation, or ROUGE;
a power consumption of the computing system;
a metric indicative of class discriminability of the output data values of the computation unit;
a difference between the output data values and one or more thresholds;
Kullback Leibler, or KL, divergence;
a statistical distance metric between output data values of the computation unit; and/or
a mean, standard deviation, or STD, skew or kurtosis of the output data values in comparison to typical values.

11. The computing system according to claim 1, wherein in response to the control signal the computation unit is operative to adjust a number of bits of the input data values or values derived therefrom that are used by the computation unit in performing said operations.

12. The computing system according to claim 11, wherein the computation unit is operative to prevent or disable use of one or more least significant bits of the input data values or values derived therefrom from being used by the computation unit in performing said operations.

13. The computing system according to claim 1, wherein said operations comprise applying a weight value to at least one received input data value or value derived therefrom and wherein the computation unit is operative to adjust a number of bits of the weight value used by the computation unit in performing said operations.

14. The computing system according to claim 13, wherein the computation unit is operative to prevent or disable use of one or more least significant bits of the weight value from being used by the computation unit in performing said operations.

15. The computing system according to claim 1, wherein said operations comprise accumulating a plurality of received input data values or data values derived therefrom to generate accumulated data values, and wherein the computation unit is operative to adjust a number of bits of the data values which are subject to the accumulation and/or of the accumulated data values.

16. The computing system according to claim 15, wherein the computation unit is operative to prevent or disable use of one or more least significant bits of the data values which are subject to the accumulation and/or of the accumulated data values.

17. An integrated circuit or a device, comprising a computing system according to claim 1.

18. A computing method comprising:
receiving, at a computation unit of a computing system, a series of input data values;
receiving, at an input of the computing system, a tunable performance parameter separate to the series of input data values,
generating, at the computation unit, a series of output data values by performing operations on at least one received input data value and/or generated output data value; and
controlling, by a controller of the computing system and as a function of the received tunable performance parameter, a level of accuracy of the operations and thereby affecting a performance metric of the computation unit.

19. A method of training or configuring a controller of a computing system comprising a computation unit and said controller, the computation unit configured to receive a series of input data values and generate a series of output data values by performing operations on at least one received input data value and/or generated output data value, the controller configured, as a function of a tunable performance parameter, to issue a control signal to the computation unit to control a level of accuracy of the operations and thereby affect a performance metric of the computation unit, the method comprising:
varying a value of the tunable performance parameter and defining said function based on an effect of varying the value of the tunable performance parameter on the performance metric; and/or
varying a value of the control signal and defining said function based on an effect of varying the value of the control signal on the performance metric; and/or
providing the computation unit with one or more training sets of input data values and defining said function based on an effect of the one or more training sets of input data values on the performance metric.

20. A non-transitory computer readable storage medium having a computer program stored thereon which, when executed on one or more processors of a computing system, causes the computing system to carry out the method of claim 18.
